(19) United States
(12) Patent Application Publication
(10) Pub. No.: US 2018/0144001 A1
(43) Pub. Date: May 24, 2018

(54) DATABASE TRANSFORMATION SERVER AND DATABASE TRANSFORMATION METHOD THEREOF

(71) Applicant: Institute For Information Industry, Taipei (TW)

(72) Inventors: Chin-Feng LAI, Tainan City (TW); Xue-Ha LIN, Taipei City (TW); Ying-Hsun LAI, Kaohsiung City (TW); Chi-Cheng CHUANG, Kaohsiung City (TW)

(21) Appl. No.: 15/375,054

(22) Filed: Dec. 9, 2016

(30) Foreign Application Priority Data
Nov. 22, 2016 (TW) 105138267

(51) Int. Cl. G06F 17/30

(52) U.S. Cl. CPC G06F 17/30297; G06F 17/30339; G06F 17/30569

(57) ABSTRACT

A database transformation server and a database transformation method thereof are provided. The database transformation server receives a plurality of rational data schema information and a rational database log. The database transformation server analyzes the rational data schema information for generating a rational table relation information, and analyzes the rational database log for generating rational table statistics information corresponding to rational data tables. The database transformation server transforms the rational data schema information into at least one piece of non-rational data schema information according to the rational table relation information, and adjusts the at least one piece of non-rational data schema information according to the rational table statistics information.

### PRIORITY

This application claims priority to Taiwan Patent Application No. 105138267 filed on Nov. 22, 2016, which is hereby incorporated by reference in its entirety.

### FIELD

The present invention relates to a database transformation server and a database transformation method thereof; and more particularly, the database transformation server and the database transformation method thereof are mainly configured to transform a rational database into a non-rational database.

### BACKGROUND

Nowadays, most of enterprises and websites adopt a rational database (e.g., Structural Query Language (SQL)) framework to accomplish data management and accessing. However, the rational database framework will experience a significant degradation in efficiency of data accessing and usage once the amount of data that need to be managed reaches a certain level. Therefore, with the advent of the big data era, the rational database framework has become inadequate, and the non-rational database has been developed correspondingly.

Because the schema used for data storage in the rational database and that used for data storage in the non-rational database differ greatly from each other, any inappropriate transformation from the legacy rational database into the non-rational database will make the increase in data accessing efficiency of the non-rational database insignificant or even degraded. This will cause troubles to the enterprises and websites and further cause inconveniences to the user.

Accordingly, joint efforts still have to be made to overcome the shortcoming possibly produced in the conventional database transformation.

### SUMMARY

The disclosure includes a database transformation method for a database transformation server. The database transformation method can comprise: (a) enabling the database transformation server to receive a plurality of pieces of rational data schema information and a rational database log from a rational database; (b) enabling the database transformation server to analyze the pieces of rational data schema information to generate a piece of rational table relation information, and analyze the rational database log to generate a piece of rational table statistics information corresponding to a plurality of rational data tables; (c) enabling the database transformation server to transform the pieces of rational data schema information into at least one piece of non-rational data schema information according to the piece of rational table statistics information; and (d) enabling the database transformation server to adjust the at least one piece of non-rational data schema information according to the piece of rational table statistics information.

The disclosure also includes a database transformation server, which can comprise a rational database analyzing unit, a database transformation unit and a non-rational database adjusting unit. The rational database analyzing unit is configured to: receive a plurality of pieces of rational data schema information and a rational database log from a rational database; and analyze the pieces of rational data schema information to generate a piece of rational table relation information, and analyze the rational database log to generate a piece of rational table statistics information corresponding to a plurality of rational data tables. The database transformation unit is configured to transform the pieces of rational data schema information into at least one piece of non-rational data schema information according to the piece of rational table statistics information. The non-rational database adjusting unit is configured to adjust the at least one piece of non-rational data schema information according to the piece of rational table statistics information.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating operations of a database transformation server according to a first embodiment of the present invention;

FIG. 1B is a block diagram of the database transformation server according to the first embodiment of the present invention;

FIG. 2A is a schematic view illustrating operations of a database transformation server according to a second embodiment of the present invention;

FIG. 2B is a block diagram of the database transformation server according to the second embodiment of the present invention;

FIG. 2C and FIG. 2D are schematic views illustrating content merging of rational data schema information according to the second embodiment of the present invention;

FIG. 2E is a schematic view illustrating a rational data schema information transformation according to the second embodiment of the present invention;

FIG. 2F is a schematic view illustrating another rational data schema information transformation according to the second embodiment of the present invention;

FIG. 3 is a flowchart diagram of a database transformation method according to a third embodiment of the present invention;

FIG. 4 is a flowchart diagram of a database transformation method according to a fourth embodiment of the present invention;

FIG. 5 is a flowchart diagram of a database transformation method according to a fifth embodiment of the present invention;

FIG. 6 is a flowchart diagram of a database transformation method according to a sixth embodiment of the present invention;

FIG. 7 is a flowchart diagram of a database transformation method according to a seventh embodiment of the present invention; and

FIG. 8 is a flowchart diagram of a database transformation method according to an eighth embodiment of the present invention.

### DETAILED DESCRIPTION

In the following descriptions, the present invention will be explained with reference to example embodiments thereof. It shall be appreciated that, these example embodiments of are not intended to limit the present invention to any specific examples, embodiments, environment, applications or particular implementations described in these example embodiments. Therefore, description of these example embodiments is only for purpose of illustration rather than to limit the present invention, and the scope of the present invention shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

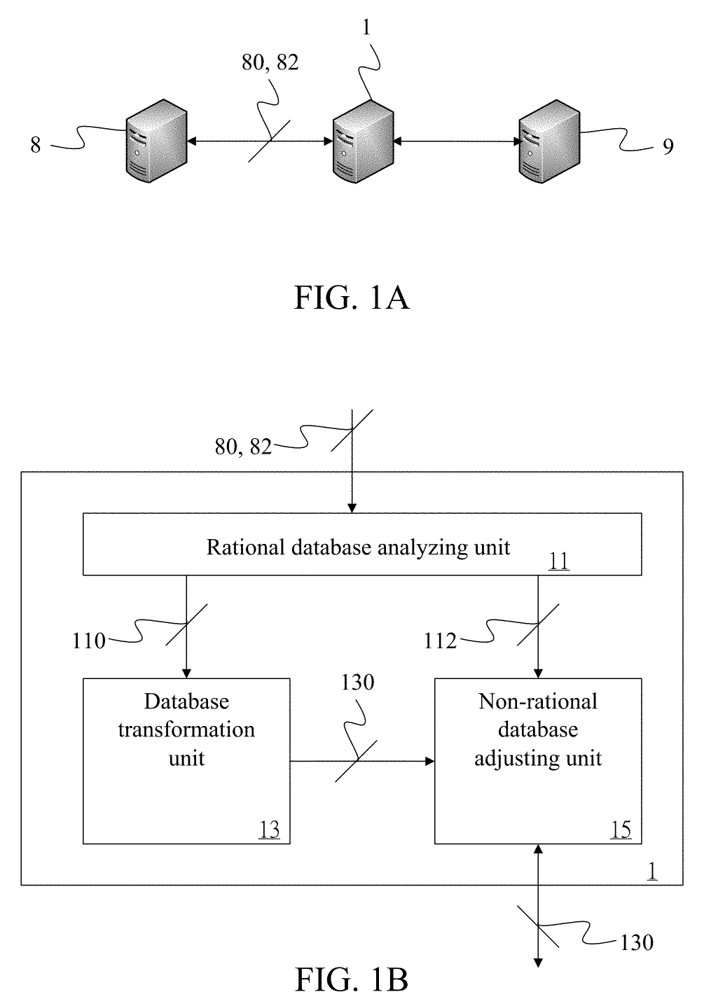

Please refer to FIG. 1A and FIG. 1B. FIG. 1A is a schematic view illustrating operations of a database transformation server 1 according to a first embodiment of the present invention, and FIG. 1B is a block diagram of the database transformation server 1 according to the first embodiment of the present invention. The database transformation server 1 comprises a rational database analyzing unit 11, a database transformation unit 13 and a non-rational database adjusting unit 15 electrically connected with each other. Interactions between these components will be further described hereinbelow.

First, the rational database analyzing unit 11 receives a plurality of pieces of rational data schema information 80 and a rational database log 82 from a rational database 8. Then the rational database analyzing unit 11 analyzes the pieces of rational data schema information 80 to generate a piece of rational table relation information 110. The rational table relation information 110 records correspondence relations between the pieces of rational data schema information 80.

Meanwhile, the rational database analyzing unit 11 analyzes the rational database log 82 to generate a piece of rational table statistics information 112 corresponding to a plurality of rational data tables. Here, the rational table statistics information 112 records various usage states of tables in the rational database.

Next, the database transformation unit 13 receives the rational table relation information 110 from the rational database analyzing unit 11, and transforms the rational data schema information 80 into at least one piece of non-rational data schema information 130 according to the correspondence relations between the pieces of rational data schema information 80 recorded in the non-rational data schema information 130.

On the other hand, the non-rational database adjusting unit 15 receives at least one piece of non-rational data schema information 130 and a piece of rational table statistics information 112 from the rational database analyzing unit 11 and the database transformation unit 13 respectively, and further adjusts the at least one piece of non-rational data schema information 130 according to the various usage states of tables in the rational database recorded in the rational table statistics information 112. Finally, the at least one piece of non-rational data schema information 130 is transmitted to a non-rational database 9 to be stored therein.

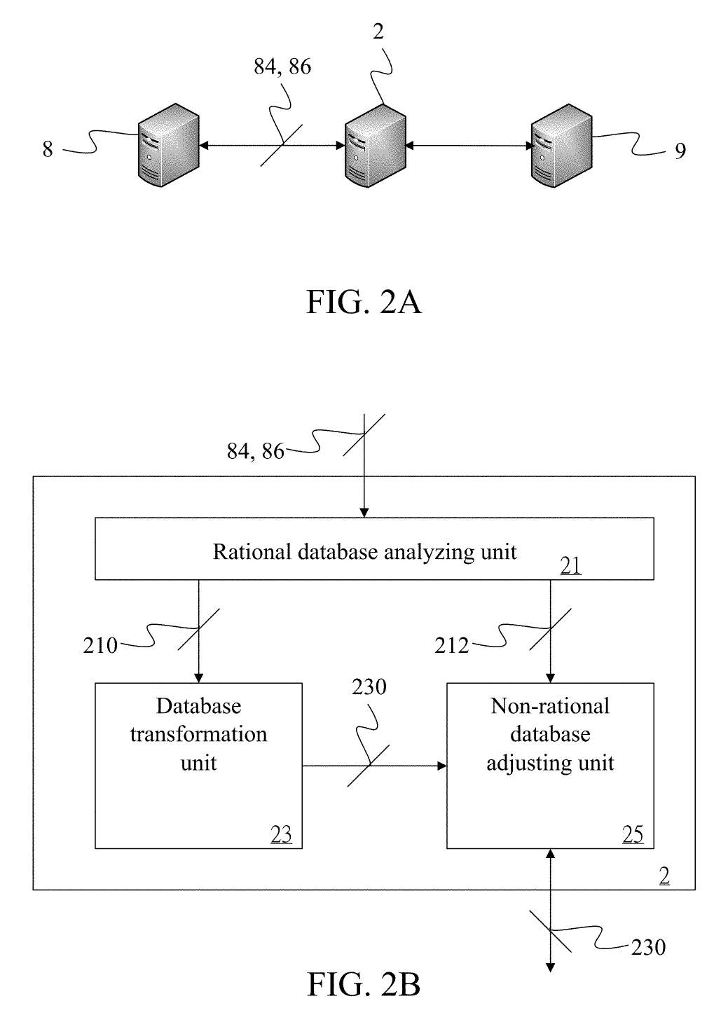

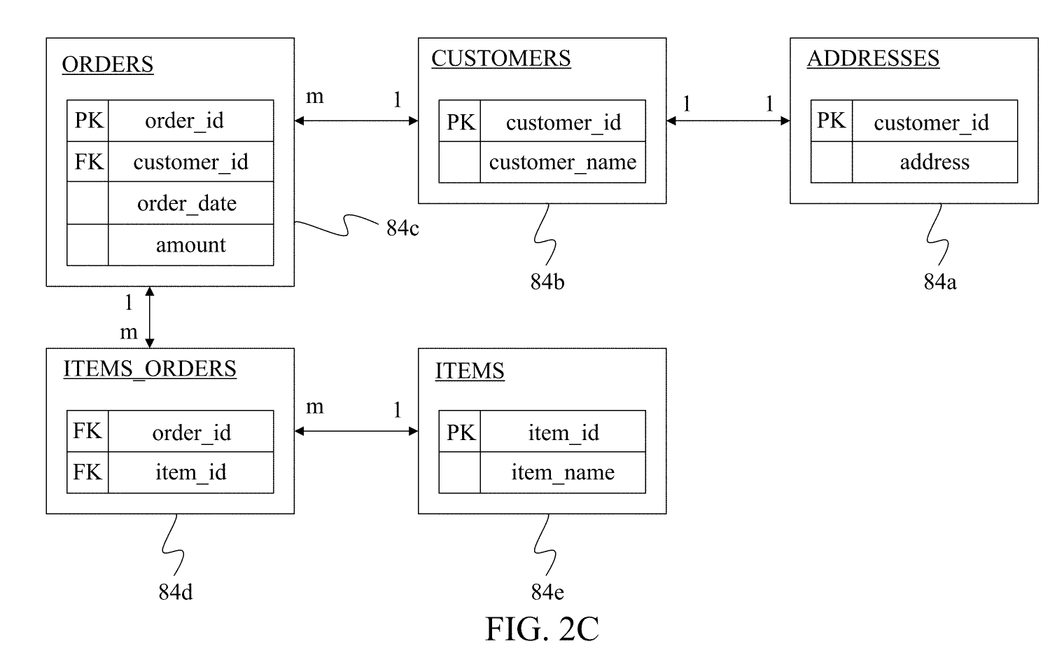

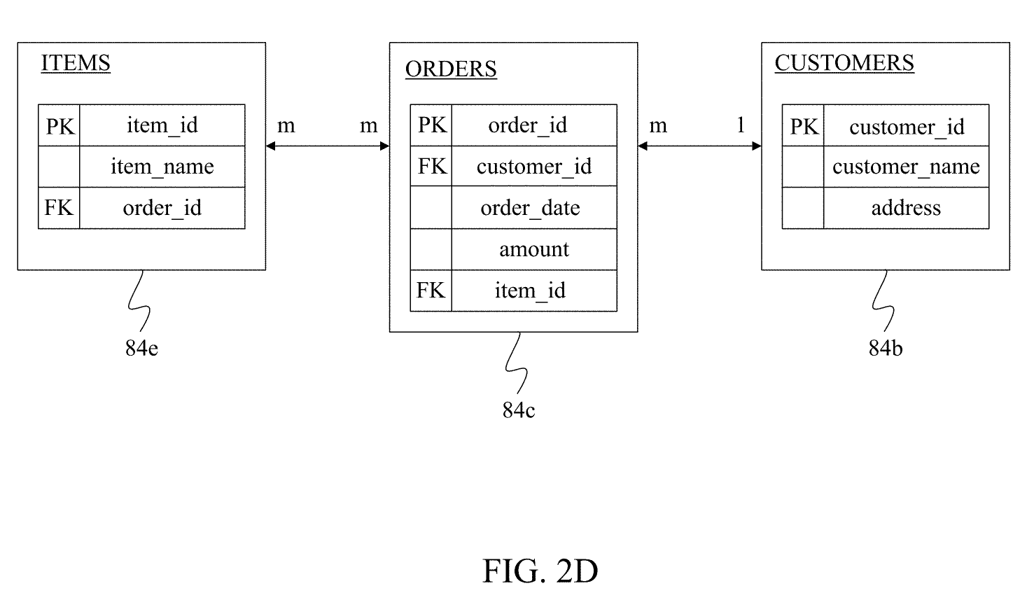

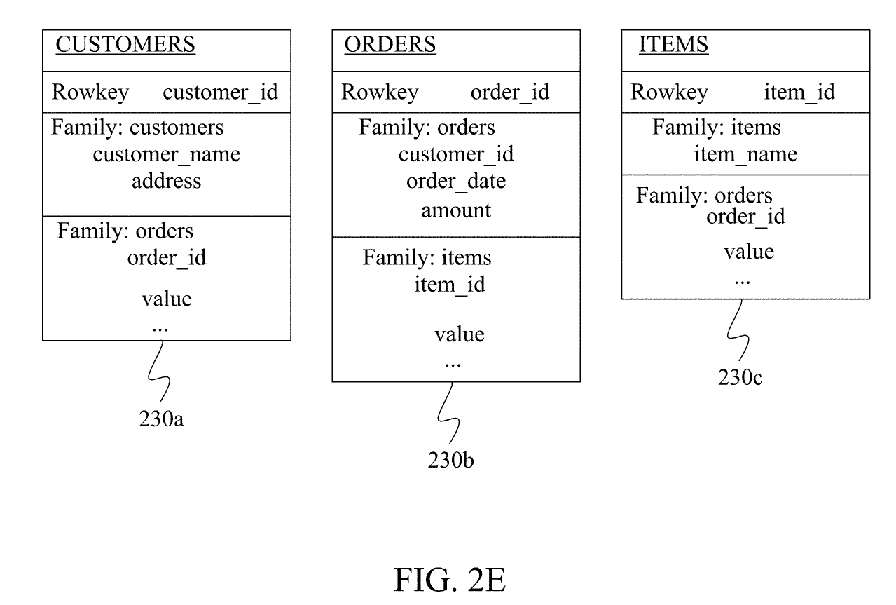

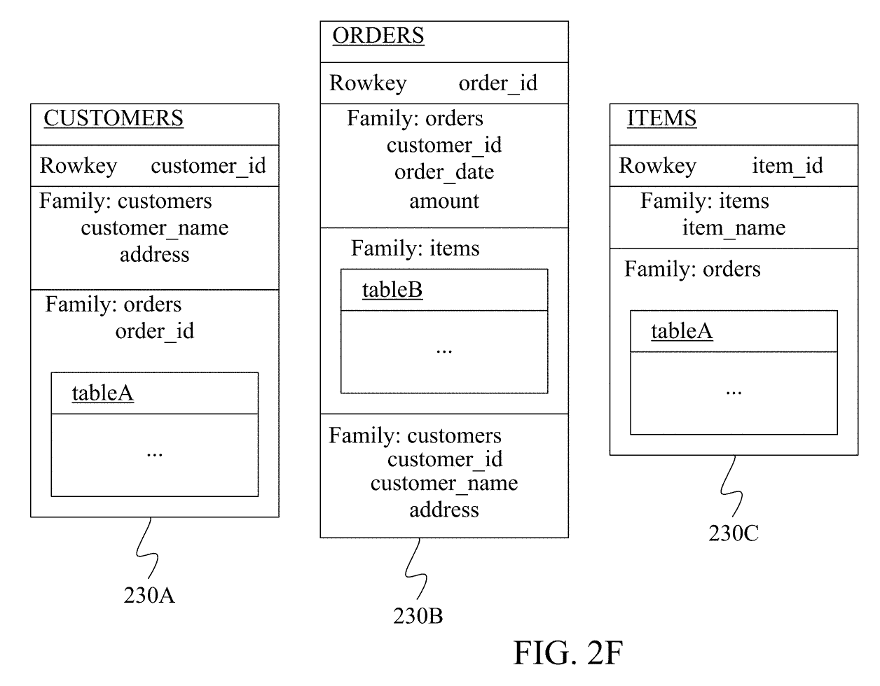

Please refer to FIG. 2A and FIG. 2B. FIG. 2A is a schematic view illustrating operations of a database transformation server 2 according to a second embodiment of the present invention, and FIG. 2B is a block diagram of the database transformation server 2 according to the second embodiment of the present invention. The database transformation server 2 comprises a rational database analyzing unit 21, a database transformation unit 23 and a non-rational database adjusting unit 25 electrically connected with each other. The second embodiment is mainly to further explain detailed database transformation operations of the database transformation server 2 with reference to an exemplary example.

First, the rational database analyzing unit 21 receives a plurality of pieces of rational data schema information 84 and a rational database log 86 from the rational database 8. It shall be appreciated that, in the second embodiment, the rational database 8 is a commonly used Structural Query Language (SQL) database, the pieces of rational data schema information 84 are schemas used in the SQL database, and the rational database log 86 is a table usage log used in the SQL database.

Then the rational database analyzing unit 21 analyzes the pieces of rational data schema information 86 to generate a piece of rational table relation information 210, and analyzes the rational database log 84 to generate a piece of rational table statistics information 212 corresponding to a plurality of rational data tables. Here, the rational table relation information 210 records correspondence relations between the pieces of rational data schema information 86, and the pieces of rational data schema information 86 have a one-to-one relation, a one-to-multiple relation, a multiple-to-multiple relation, or a combination thereof therebetween according to correspondence states of primary keys and foreign keys.

Please further refer to FIG. 2C and FIG. 2D, which are schematic views illustrating content merging of the rational data schema information 84 according to the second embodiment of the present invention. In the second embodiment, the plurality of pieces of rational data schema information 84 include rational data schema information 84a-84e. The rational data schema information 84a and the rational data schema information 84b have a one-to-one relation therebetween (the 1-1 relation between the tables as illustrated) according to the primary key “customer_id”.

Accordingly, the database transformation unit 23 selects pieces of rational data schema information having a one-to-one relation therebetween (i.e., the rational data schema information 84a and the rational data schema information 84b in the second embodiment) from the pieces of rational data schema information 84 according to the rational table relation information 210, and merges data of the rational data schema information 84a into the rational data schema information 84b.

On the other hand, in the second embodiment, the primary key “order_id” of the rational data schema information 84c and the foreign key “order_id” of the rational data schema information 84d have a one-to-multiple relation therebetween (the 1-m relation between the tables as illustrated), and the primary key “item_id” of the rational data schema information 84e and the foreign key “item_id” of the rational data schema information 84d have a one-to-multiple relation therebetween (the 1-m relation between the tables as illustrated), so the rational data schema information 84c and the rational data schema information 84e have a multiple-to-multiple relation therebetween.

Accordingly, the database transformation unit 23 selects pieces of rational data schema information having a multiple-to-multiple relation therebetween (i.e., the rational data schema information 84c and the rational data schema information 84e in the second embodiment) from the pieces of rational data schema information 84 according to the rational table relation information 210, and merges the foreign keys “order_id” and “item_id” of the rational data schema information 84d used as an intermediary into the rational data schema information 84e into the rational data schema information 84c respectively.

After merging of the rational data schema information 84 has been completed, the database transformation unit 23 further transforms the merged rational data schema information 84 into at least one piece of non-rational data schema information 230 according to the rational table relation information 210. Please refer to FIG. 2E together, which is a schematic view illustrating transformation of the rational data schema information 84 according to the second embodiment of the present invention.

Specifically in the second embodiment, the database transformation unit 23 first transforms the primary key (i.e., “customer_id” as illustrated) of the rational data schema information 84b into a rowkey of the non-rational data schema information 230a according to the rational table relation information 210, and transforms the remaining keys (i.e., “customer_name” and “address”) of the rational data schema information 84b into a field value of the family (i.e., “family: customers”) of non-rational data schema information 230a by taking the name (i.e., “CUSTOMERS”) of the rational data schema information 84b as a family title.

Then, the database transformation unit 23 determines that a foreign key (i.e., “customer_id” as illustrated) of the rational data schema information 84c corresponds to the primary key of the rational data schema information 84b, so the database transformation unit 23 transforms the primary key (i.e., “order_id” as illustrated) of the rational data schema information 84b into a field value of the family (i.e., “family:orders”) of non-rational data schema information 230a by taking the name (i.e., “ORDERS”) of the rational data schema information 84b as the family title.

Similarly, the database transformation unit 23 first transforms the primary key (i.e., “order_id” as illustrated) of the rational data schema information 84c into a rowkey of the non-rational data schema information 230b according to the rational table relation information 210, and transforms the remaining keys (i.e., “customer_id”, “order_date” and “amount”) of the rational data schema information 84c into a field value of the family (i.e., “family: orders”) of non-rational data schema information 230b by taking the name (i.e., “ORDERS”) of the rational data schema information 84c as a family title.

Meanwhile, the database transformation unit 23 determines that a foreign key (i.e., “order_id” as illustrated) of the rational data schema information 84e corresponds to the primary key of the rational data schema information 84c, so the database transformation unit 23 transforms the primary key (i.e., “item_id” as illustrated) of the rational data schema information 84e into a field value of the family (i.e., “family:items”) of non-rational data schema information 230b by taking the name (i.e., “ITEMS”) of the rational data schema information 84e as the family title.

Likewise, the database transformation unit 23 first transforms the primary key (i.e., “item_id” as illustrated) of the rational data schema information 84e into a rowkey of the non-rational data schema information 230c according to the rational table relation information 210, and transforms the remaining key (i.e., “item_name”) of the rational data schema information 84e into a field value of the family (i.e., “family: items”) of non-rational data schema information 230c by taking the name (i.e., “ITEMS”) of the rational data schema information 84e as a family title.

Then, the database transformation unit 23 determines that a foreign key (i.e., “item_id” as illustrated) of the rational data schema information 84c corresponds to the primary key of the rational data schema information 84e, so the database transformation unit 23 transforms the primary key (i.e., “order_id” as illustrated) of the rational data schema information 84c into a field value of the family (i.e., “family: orders”) of non-rational data schema information 230c by taking the name (i.e., “ORDERS”) of the rational data schema information 84c as the family title.

Please refer to FIG. 2F together, which is a schematic view illustrating another transformation of the rational data schema information 84 according to the second embodiment of the present invention. Specifically in another implementation of the second embodiment, the database transformation unit 23 may first transform the primary key (i.e., “customer_id” as illustrated) of the rational data schema information 84b into a rowkey of the non-rational data schema information 230A, and transform the remaining keys (i.e., “customer_name” and “address”) of the rational data schema information 84b into a field value of the family (i.e., “family: customers”) of non-rational data schema information 230A by taking the name (i.e., “CUSTOMERS”) of the rational data schema information 84b as a family title.

Then, the database transformation unit 23 determines that the rational data schema information 84b and the rational data schema information 84c have a one-to-multiple relation therebetween, so the database transformation unit 23 directly merges a table tableA corresponding to the rational data schema information 84c into the family (i.e., “family:orders”) of non-rational data schema information 230A by taking the name (i.e., “ORDERS”) of the rational data schema information 84c as the family title.

Similarly, the database transformation unit 23 first transforms the primary key (i.e., “order_id” as illustrated) of the rational data schema information 84c into a rowkey of the non-rational data schema information 230B, and transforms the remaining keys (i.e., “customer_id”, “order_date” and “amount”) of the rational data schema information 84c into a field value of the family (i.e., “family: orders”) of non-rational data schema information 230B by taking the name (i.e., “CUSTOMERS”) of the rational data schema information 84c as a family title.

Then, when the database transformation unit 23 determines that the primary key (i.e., “item_id”) of the rational data schema information 84e and the foreign key of the rational data schema information 84c have a one-to-multiple relation therebetween, the database transformation unit 23 directly merges a table tableB corresponding to the rational data schema information 84e into the family (i.e., “family: items”) of non-rational data schema information 230B by taking the name (i.e., “ITEMS”) of the rational data schema information 84e as the family title.

On the other hand, when the database transformation unit 23 determines that the primary key (i.e., “customer_id”) of the rational data schema information 84b and the foreign key of the rational data schema information 84c have a one-to-multiple relation therebetween, the database transformation unit 23 directly merges the rational data schema information 84b into the non-rational data schema information 230B by taking the name (i.e., “CUSTOMERS”) of the rational data schema information 84b as the family title.

Likewise, the database transformation unit 23 first transforms the primary key (i.e., “item_id” as illustrated) of the rational data schema information 84e into a rowkey of the non-rational data schema information 230C, and transforms the remaining key (i.e., “item_name”) of the rational data schema information 84e into a field value of the family (i.e., “family: items”) of non-rational data schema information 230C by taking the name (i.e., “ITEMS”) of the rational data schema information 84e as a family title.

Then, when the database transformation unit 23 determines that the primary key (i.e., “order_id”) of the rational data schema information 84c and the foreign key of the rational data schema information 84e have a one-to-multiple relation therebetween, the database transformation unit 23 directly merges a table tableA corresponding to the rational data schema information 84c into the family (i.e., “family:order”) of non-rational data schema information 230C by taking the name (i.e., “ORDERS”) of the rational data schema information 84c as the family title.

It shall be particularly appreciated that, the user may transform the database in either of the aforesaid two transformation manners (i.e., the transformation manners in FIG. 2E and FIG. 2F) depending on his or her needs; however, the second transformation manner may result in more families and tables in the non-rational data schema information, so adjustment may be made subsequently according to the table usage conditions.

In detail, in the second embodiment, the rational table statistics information 212 comprises a table correlation between a first rational data table (not shown) and a second rational data table (not shown) among the rational data tables, and the non-rational database adjusting unit 25 is configured to determine whether a number of times that the first rational data table and the second rational data table are accessed at the same time is greater than an access times threshold according to the table correlation and whether a sum of sizes of the first rational data table and the second rational data table is smaller than a table size threshold.

In detail, in consideration that a larger number of times that the first rational data table and the second rational data table are accessed at the same time represents a higher correlation between the tables and in order to avoid storing excessive table contents in a single family of non-rational data schema information to cause poor accessing performance, the non-rational database adjusting unit 25 integrates the first rational table and the second rational table into a same family to improve the performance and to avoid redundant data when it is determined that the number of times that the first rational data table and the second rational data table are accessed at the same time is greater than an access times threshold and the sum of sizes of the first rational data table and the second rational data table is smaller than a table size threshold.

It shall be particularly appreciated that, the rational database analyzing unit, the database transformation unit and the non-rational database adjusting unit of the aforesaid embodiments are comprised of related computing circuits (e.g., processor circuits) hardware or combination of circuits, and because this can be readily understood by those skilled in the art, it will not be further described herein.

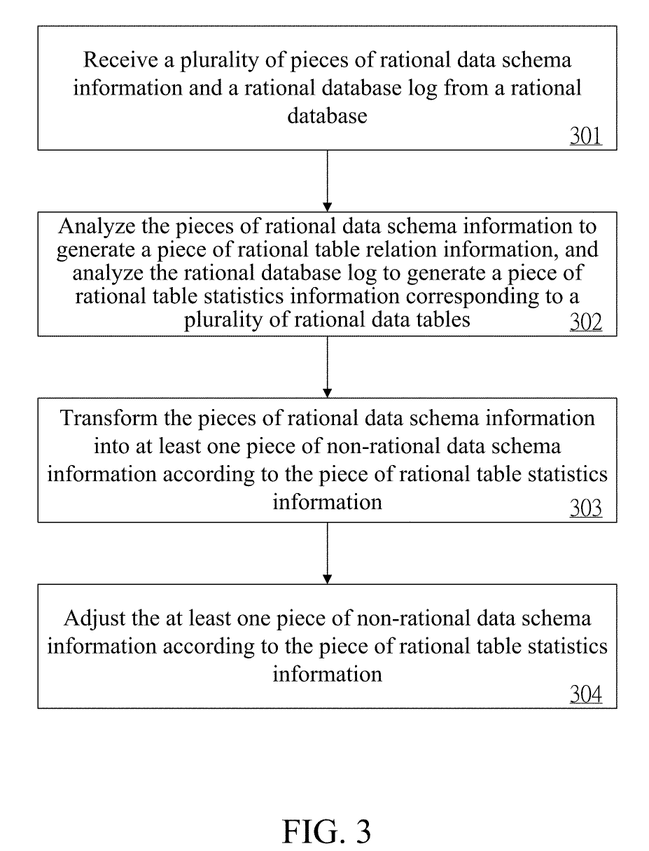

A third embodiment of the present invention is a database transformation method, a flowchart diagram of which shown in FIG. 3. The method of the third embodiment is for use in a database transformation server (e.g., the database transformation server 1 of the previous embodiment). Detailed steps of the third embodiment are described as follows.

First, step 301 is executed to enable the database transformation server to receive a plurality of pieces of rational data schema information and a rational database log from a rational database. Step 302 is executed to enable the database transformation server to analyze the pieces of rational data schema information to generate a piece of rational table relation information, and analyze the rational database log to generate a piece of rational table statistics information corresponding to a plurality of rational data tables.

Then, step 303 is executed to enable the database transformation server to transform the pieces of rational data schema information into at least one piece of non-rational data schema information according to the piece of rational table statistics information. Finally, step 304 is executed to enable the database transformation server to adjust the at least one piece of non-rational data schema information according to the piece of rational table statistics information.

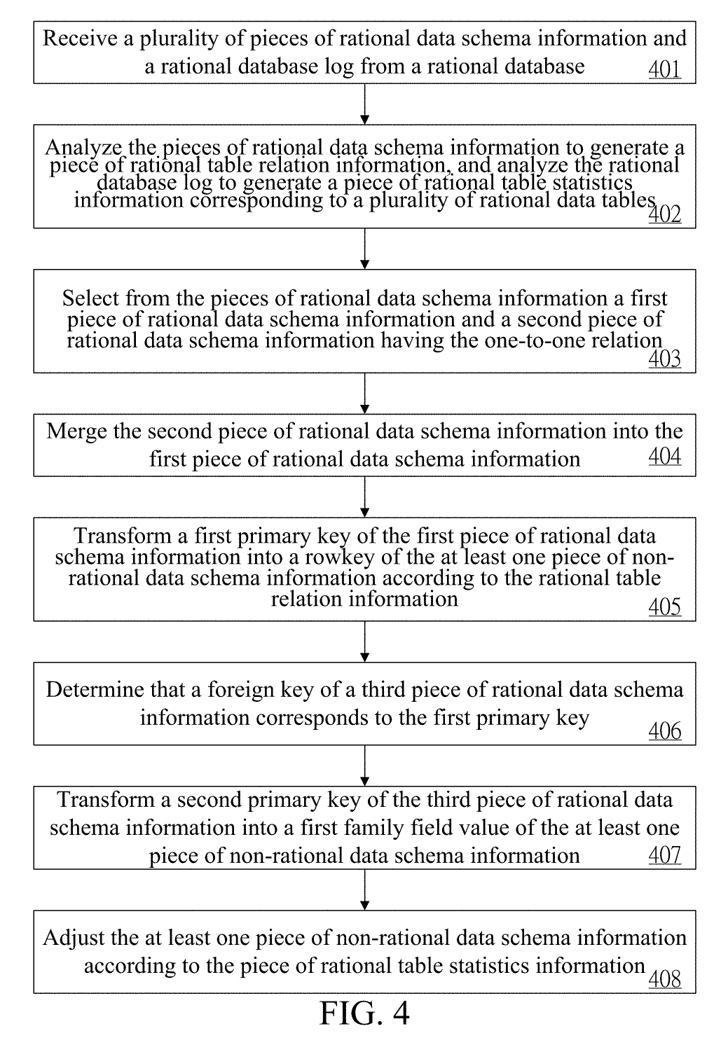

A fourth embodiment of the present invention is a database transformation method, a flowchart diagram of which is shown in FIG. 4. The method of the fourth embodiment is for use in a database transformation server (e.g., the database transformation server 2 of the previous embodiment). Detailed steps of the fourth embodiment are described as follows.

First, step 401 is executed to enable the database transformation server to receive a plurality of pieces of rational data schema information and a rational database log from a rational database. Step 402 is executed to enable the database transformation server to analyze the pieces of rational data schema information to generate a piece of rational table relation information, and analyze the rational database log to generate a piece of rational table statistics information corresponding to a plurality of rational data tables. The rational table relation information comprises a one-to-one relation, a one-to-multiple relation, a multiple-to-multiple relation, or a combination thereof corresponding to the pieces of rational data schema information.

Then, step 403 is executed to enable the database transformation server to select from the pieces of rational data schema information a first piece of rational data schema information and a second piece of rational data schema information having the one-to-one relation. Step 404 is executed to enable the database transformation server to merge the second piece of rational data schema information into the first piece of rational data schema information.

Next, step 405 is executed to enable the database transformation server to transform a first primary key of the first piece of rational data schema information into a rowkey of the at least one piece of non-rational data schema information according to the rational table relation information. Thereafter, step 406 is executed to enable the database transformation server to determine that a foreign key of a third piece of rational data schema information corresponds to the first primary key.

Step 407 is executed to enable the database transformation server to transform a second primary key of the third piece of rational data schema information into a first family field value of the at least one piece of non-rational data schema information. Step 408 is executed to adjust the at least one piece of non-rational data schema information according to the piece of rational table statistics information.

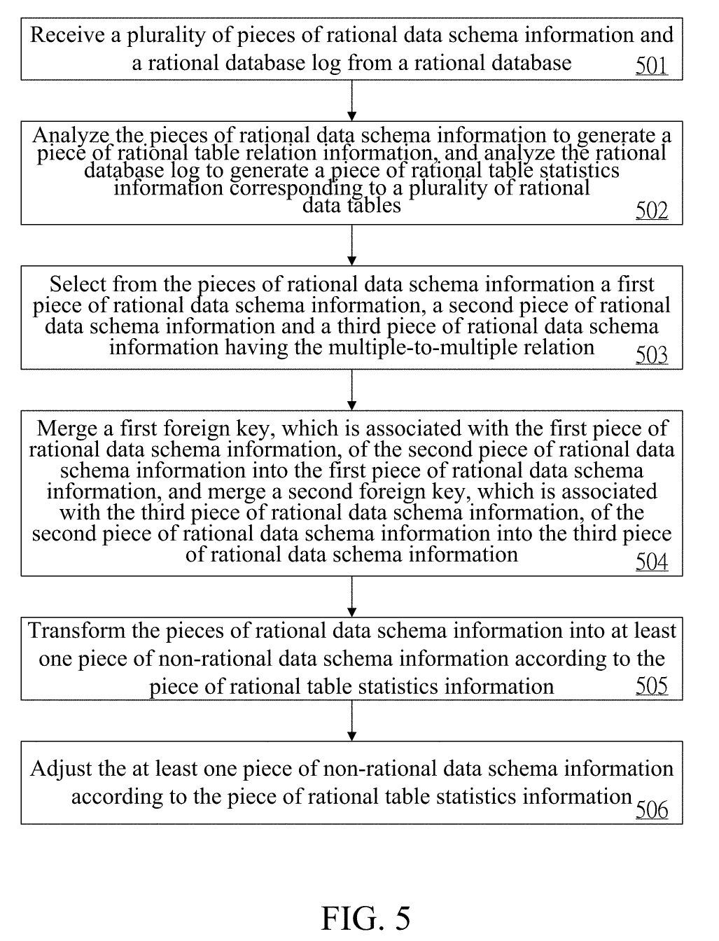

A fifth embodiment of the present invention is a database transformation method, a flowchart diagram of which is shown in FIG. 5. The method of the fifth embodiment is for use in a database transformation server (e.g., the database transformation server 2 of the previous embodiment). Detailed steps of the fifth embodiment are described as follows.

First, step 501 is executed to enable the database transformation server to receive a plurality of pieces of rational data schema information and a rational database log from a rational database. Step 502 is executed to enable the database transformation server to analyze the pieces of rational data schema information to generate a piece of rational table relation information, and analyze the rational database log to generate a piece of rational table statistics information corresponding to a plurality of rational data tables. The rational table relation information comprises a one-to-one relation, a one-to-multiple relation, a multiple-to-multiple relation, or a combination thereof corresponding to the pieces of rational data schema information.

Then, step 503 is executed to enable the database transformation server to select from the pieces of rational data schema information a first piece of rational data schema information, a second piece of rational data schema information and a third piece of rational data schema information having the multiple-to-multiple relation. The first piece of rational data schema information and the third piece of rational data schema information have the one-to-multiple relation with the second piece of rational data schema information respectively.

Step 504 is executed to enable the database transformation server to merge a first foreign key, which is associated with the first piece of rational data schema information, of the second piece of rational data schema information into the first piece of rational data schema information, and merge a second foreign key, which is associated with the third piece of rational data schema information, of the second piece of rational data schema information into the third piece of rational data schema information.

Then, step 505 is executed to enable the database transformation server to transform the pieces of rational data schema information into at least one piece of non-rational data schema information according to the piece of rational table statistics information. Finally, step 506 is executed to enable the database transformation server to adjust the at least one piece of non-rational data schema information according to the piece of rational table statistics information.

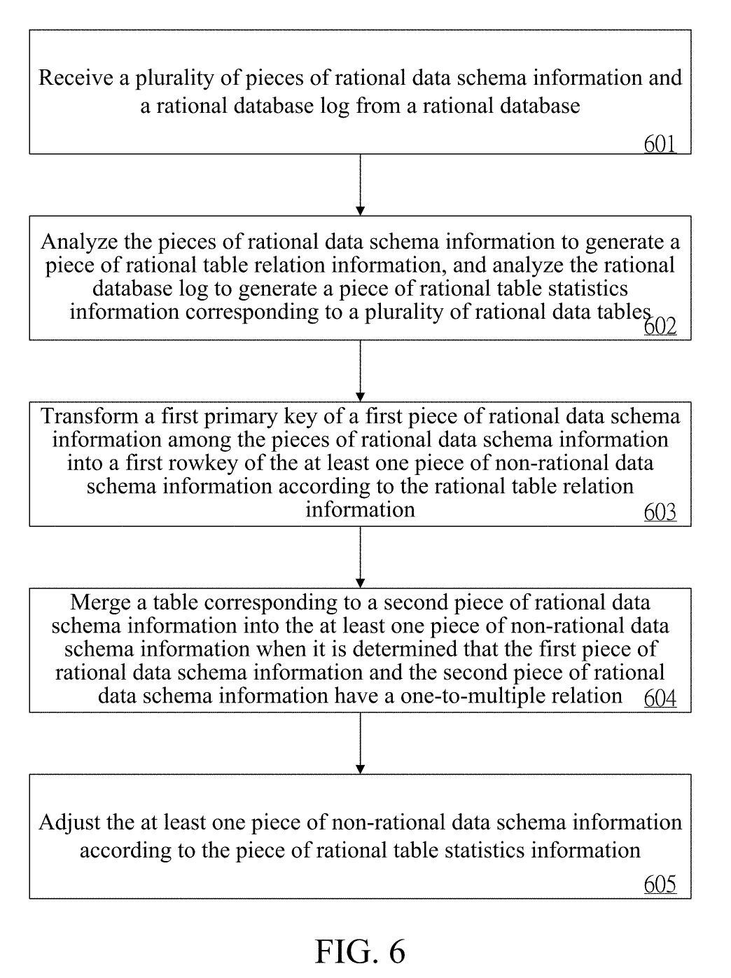

A sixth embodiment of the present invention is a database transformation method, a flowchart diagram of which is shown in FIG. 6. The method of the sixth embodiment is for use in a database transformation server (e.g., the database transformation server 2 of the previous embodiment). Detailed steps of the sixth embodiment are described as follows.

First, step 601 is executed to enable the database transformation server to receive a plurality of pieces of rational data schema information and a rational database log from a rational database. Step 602 is executed to enable the database transformation server to analyze the pieces of rational data schema information to generate a piece of rational table relation information, and analyze the rational database log to generate a piece of rational table statistics information corresponding to a plurality of rational data tables. The rational table relation information comprises a one-to-one relation, a one-to-multiple relation, a multiple-to-multiple relation, or a combination thereof corresponding to the pieces of rational data schema information.

Then, step 603 is executed to enable the database transformation server to transform a first primary key of a first piece of rational data schema information among the pieces of rational data schema information into a first rowkey of the at least one piece of non-rational data schema information according to the rational table relation information. Step 604 is executed to enable the database transformation server to merge a table corresponding to a second piece of rational data schema information into the at least one piece of non-rational data schema information when it is determined that the first piece of rational data schema information and the second piece of rational data schema information have a one-to-multiple relation. Finally, step 605 is executed to enable the database transformation server to adjust the at least one piece of non-rational data schema information according to the piece of rational table statistics information.

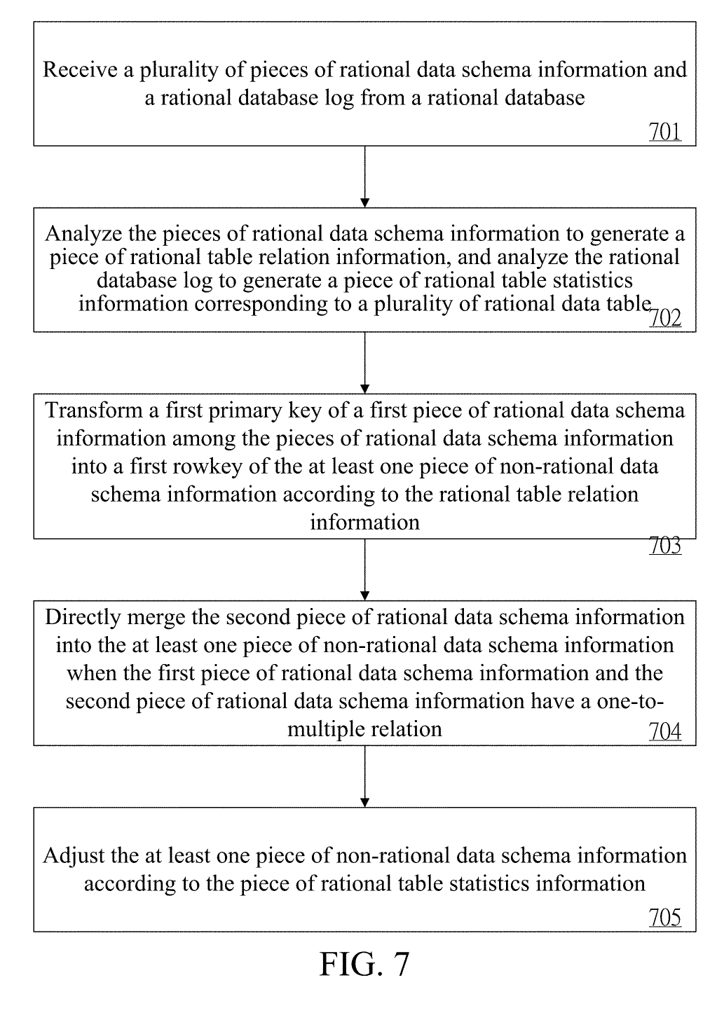

A seventh embodiment of the present invention is a database transformation method, a flowchart diagram of which is shown in FIG. 7. The method of the seventh embodiment is for use in a database transformation server (e.g., the database transformation server 2 of the previous embodiment). Detailed steps of the seventh embodiment are described as follows.

First, step 701 is executed to enable the database transformation server to receive a plurality of pieces of rational data schema information and a rational database log from a rational database. Step 702 is executed to enable the database transformation server to analyze the pieces of rational data schema information to generate a piece of rational table relation information, and analyze the rational database log to generate a piece of rational table statistics information corresponding to a plurality of rational data tables. The rational table relation information comprises a one-to-one relation, a one-to-multiple relation, a multiple-to-multiple relation, or a combination thereof corresponding to the pieces of rational data schema information.

Then, step 703 is executed to enable the database transformation server to transform a first primary key of a first piece of rational data schema information among the pieces of rational data schema information into a first rowkey of the at least one piece of non-rational data schema information according to the rational table relation information. Step 704 is executed to enable the database transformation server to directly merge the second piece of rational data schema information into the at least one piece of non-rational data schema information when the first piece of rational data schema information and the second piece of rational data schema information have a one-to-multiple relation. Finally, step 705 is executed to enable the database transformation server to adjust the at least one piece of non-rational data schema information according to the piece of rational table statistics information.

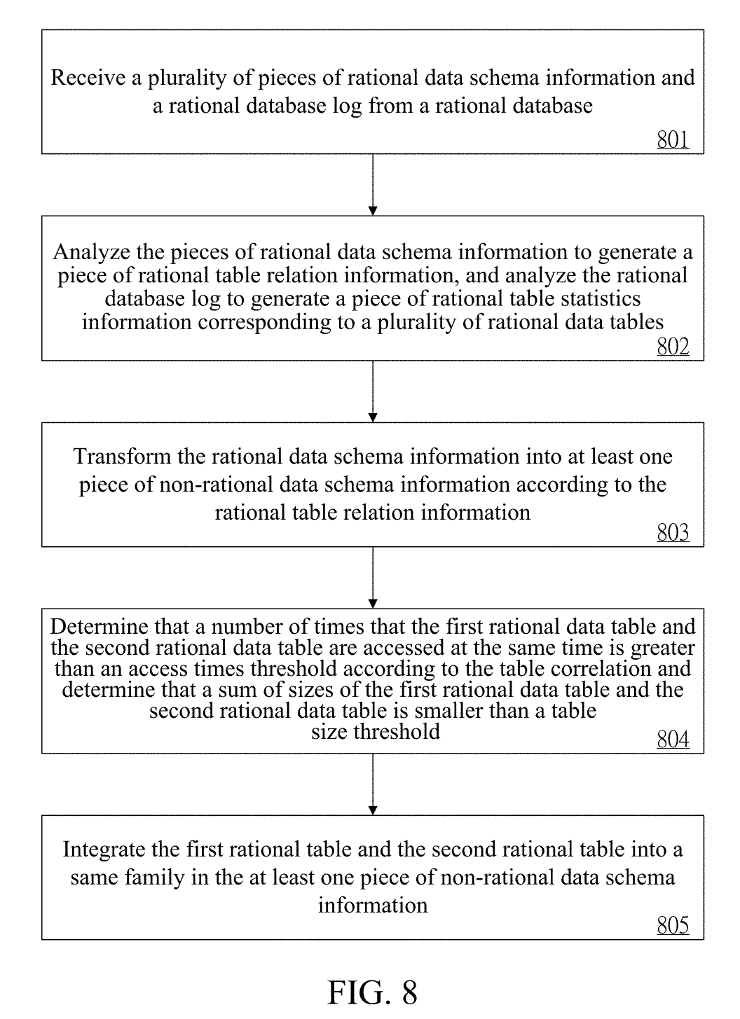

An eighth embodiment of the present invention is a database transformation method, a flowchart diagram of which is shown in FIG. 8. The method of the eighth embodiment is for use in a database transformation server (e.g., the database transformation server 2 of the previous embodiment). Detailed steps of the eighth embodiment are described as follows.

First, step 801 is executed to enable the database transformation server to receive a plurality of pieces of rational data schema information and a rational database log from a rational database. Step 802 is executed to enable the database transformation server to analyze the pieces of rational data schema information to generate a piece of rational table relation information, and analyze the rational database log to generate a piece of rational table statistics information corresponding to a plurality of rational data tables.

It shall be particularly appreciated that, the rational table statistics information comprises a table correlation between a first rational data table and a second rational data table among the rational data tables. Then, step 803 is executed to enable the database transformation server to transform the rational data schema information into at least one piece of non-rational data schema information according to the rational table relation information.

Step 804 is executed to enable the database transformation server to determine that a number of times that the first rational data table and the second rational data table are accessed at the same time is greater than an access times threshold according to the table correlation and determine that a sum of sizes of the first rational data table and the second rational data table is smaller than a table size threshold. Step 805 is executed to enable the database transformation server to integrate the first rational table and the second rational table into a same family in the at least one piece of non-rational data schema information according to the result of the step 804.

According to the above descriptions, the database transformation server and the database transformation method thereof according to the present invention can correctly transform a rational database into a non-rational database, and further adjust the transformed non-rational database according to usage relations between tables to achieve a balance between the data amount and the accessing speed. Thereby, the shortcoming of the prior art gets improved effectively.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A database transformation method for a database transformation server, the database transformation method comprising:
(a) the database transformation server receiving a plurality of pieces of rational data schema information and a rational database log from a rational database;
(b) the database transformation server analyzing the pieces of rational data schema information to generate a piece of rational table relation information, and analyze the rational database log to generate a piece of rational table statistics information corresponding to a plurality of rational data tables;
(c) the database transformation server transforming the pieces of rational data schema information into at least one piece of non-rational data schema information according to the piece of rational table statistics information; and
(d) the database transformation server adjusting the at least one piece of non-rational data schema information according to the piece of rational table statistics information.

2. The database transformation method according to claim 1, wherein the rational table relation information comprises a one-to-one relation, a one-to-multiple relation, a multiple-to-multiple relation, or a combination thereof corresponding to the pieces of rational data schema information.

3. The database transformation method according to claim 2, further comprising the following steps before the step (c):
(c1) the database transformation server selecting from the pieces of rational data schema information a first piece of rational data schema information and a second piece of rational data schema information having the one-to-one relation; and
(c2) the database transformation server merging the first piece of rational data schema information and the second piece of rational data schema information with each other.

4. The database transformation method according to claim 2, further comprising the following steps before the step (c):
(c1) the database transformation server selecting from the pieces of rational data schema information a first piece of rational data schema information, a second piece of rational data schema information and a third piece of rational data schema information having the multiple-to-multiple relation, wherein the first piece of rational data schema information and the third piece of rational data schema information have the one-to-multiple relation with the second piece of rational data schema information respectively; and
(c2) the database transformation server merging a first foreign key, which is associated with the first piece of rational data schema information, of the second piece of rational data schema information into the first piece of rational data schema information, and merge a second foreign key, which is associated with the third piece of rational data schema information, of the second piece of rational data schema information into the third piece of rational data schema information.

5. The database transformation method according to claim 1, wherein the step (c) further comprises:
(c1) the database transformation server transforming a first primary key of a first piece of rational data schema information among the pieces of rational data schema information into a first rowkey of the at least one piece of non-rational data schema information according to the rational table relation information;
(c2) the database transformation server determining that a second foreign key of a second piece of rational data schema information corresponds to the first primary key; and
(c3) the database transformation server transforming a second primary key of the second piece of rational data schema information into a first family field value of the at least one piece of non-rational data schema information.

6. The database transformation method according to claim 1, wherein the step (c) further comprises:
(c1) the database transformation server transforming a first primary key of a first piece of rational data schema information among the pieces of rational data schema information into a first rowkey of the at least one piece of non-rational data schema information according to the rational table relation information; and
(c2) the database transformation server merging a second table corresponding to a second piece of rational data schema information into the at least one piece of non-rational data schema information, wherein the first piece of rational data schema information and the second piece of rational data schema information have a one-to-multiple relation.

7. The database transformation method according to claim 1, wherein the step (c) further comprises:
(c1) the database transformation server transforming a first primary key of a first piece of rational data schema information among the pieces of rational data schema information into a first rowkey of the at least one piece of non-rational data schema information according to the rational table relation information; and
(c2) the database transformation server merging a second piece of rational data schema information into the at least one piece of non-rational data schema information, wherein the second piece of rational data schema information and the first piece of rational data schema information have a one-to-multiple relation.

8. The database transformation method according to claim 1, wherein the rational table statistics information comprises a table correlation between a first rational data table and a second rational data table among the rational data tables, and the step (d) further comprises:
(c2) the database transformation server determining that a number of times that the first rational data table and the second rational data table are accessed at the same time is greater than an access times threshold according to the table correlation and that a sum of sizes of the first rational data table and the second rational data table is smaller than a table size threshold; and
(c2) the database transformation server integrating the first rational table and the second rational table into a same family in the at least one piece of non-rational data schema information according to the result of the step (d1).

9. A database transformation server, comprising:
a rational database analyzing unit, being configured to:
receive a plurality of pieces of rational data schema information and a rational database log from a rational database; and
analyze the pieces of rational data schema information to generate a piece of rational table relation information, and analyze the rational database log to generate a piece of rational table statistics information corresponding to a plurality of rational data tables;
a database transformation unit, being configured to transform the pieces of rational data schema information into at least one piece of non-rational data schema information according to the piece of rational table statistics information; and
a non-rational database adjusting unit, being configured to adjust the at least one piece of non-rational data schema information according to the piece of rational table statistics information.

10. The database transformation server according to claim 9, wherein the rational table relation information comprises a one-to-one relation, a one-to-multiple relation, a multiple-to-multiple relation, or a combination thereof corresponding to the pieces of rational data schema information.

11. The database transformation server according to claim 10, wherein the database transformation unit is further configured to:
select from the pieces of rational data schema information a first piece of rational data schema information and a second piece of rational data schema information having the one-to-one relation; and
merge the first piece of rational data schema information and the second piece of rational data schema information with each other.

12. The database transformation server according to claim 10, wherein the database transformation unit is further configured to:
select from the pieces of rational data schema information a first piece of rational data schema information, a second piece of rational data schema information and a third piece of rational data schema information having the multiple-to-multiple relation, wherein the first piece of rational data schema information and the third piece of rational data schema information have the one-to-multiple relation with the second piece of rational data schema information respectively; and
merge a first foreign key, which is associated with the first piece of rational data schema information, of the second piece of rational data schema information into the first piece of rational data schema information, and merge a second foreign key, which is associated with the third piece of rational data schema information, of the second piece of rational data schema information into the third piece of rational data schema information.

13. The database transformation server according to claim 9, wherein the database transformation unit is further configured to:
transform a first primary key of a first piece of rational data schema information among the pieces of rational data schema information into a first rowkey of the at least one piece of non-rational data schema information according to the rational table relation information;
determine that a second foreign key of a second piece of rational data schema information corresponds to the first primary key; and
transform a second primary key of the second piece of rational data schema information into a first family field value of the at least one piece of non-rational data schema information.

14. The database transformation server according to claim 9, wherein the database transformation unit is further configured to:
transform a first primary key of a first piece of rational data schema information among the pieces of rational data schema information into a first rowkey of the at least one piece of non-rational data schema information according to the rational table relation information; and
merge a second table corresponding to a second piece of rational data schema information into the at least one piece of non-rational data schema information, wherein the first piece of rational data schema information and the second piece of rational data schema information have a one-to-multiple relation.

15. The database transformation server according to claim 9, wherein the database transformation unit is further configured to:
transform a first primary key of a first piece of rational data schema information among the pieces of rational data schema information into a first rowkey of the at least one piece of non-rational data schema information according to the rational table relation information; and
merge a second piece of rational data schema information into the at least one piece of non-rational data schema information, wherein the second piece of rational data schema information and the first piece of rational data schema information have a one-to-multiple relation.

16. The database transformation server according to claim 9, wherein the rational table statistics information comprises a table correlation between a first rational data table and a second rational data table among the rational data tables, and the non-rational database adjusting unit is further configured to:
determine that a number of times that the first rational data table and the second rational data table are accessed at the same time is greater than an access times threshold according to the table correlation and that a sum of sizes of the first rational data table and the second rational data table is smaller than a table size threshold; and
integrate the first rational table and the second rational table into a same family in the at least one piece of non-rational data schema information.
